(19) United States
(12) Patent Application Publication
(10) Pub. No.: US 2015/0180777 A1
(43) Pub. Date: Jun. 25, 2015

(54) DATA PROCESSING APPARATUS AND METHOD

(71) Applicant: ELECTRONICS AND TELECOMMUNICATIONS RESEARCH INSTITUTE, Daejeon-City (KR)

(72) Inventors: Chi-Hoon SHIN, Daejeon (KR); Chan-Ho PARK, Daejeon (KR)

(73) Assignee: ELECTRONICS AND TELECOMMUNICATIONS RESEARCH INSTITUTE, Daejeon-City (KR)

(21) Appl. No.: 14/560,554

(22) Filed: Dec. 4, 2014

(30) Foreign Application Priority Data
Dec. 19, 2013 (KR) 10-2013-0159090

(51) Int. Cl. H04L 12/741

(52) U.S. Cl. CPC H04L 45/74

(57) ABSTRACT

Disclosed herein is a data processing apparatus and method. The data processing apparatus includes a terminal communication unit. A first control unit extracts a command packet based on a command block wrapper packet. A first unit-side communication unit transmits the command packet to a second unit. When the first unit-side communication unit receives a data status packet, generated based on one or more data packets responding to the command packet, from the second unit, the first control unit extracts a data packet from the data status packet in response to a packet for a data transmission request of a host terminal, and wherein the terminal communication unit transmits the data packet extracted from the data status packet to the host terminal.

### CROSS REFERENCE TO RELATED APPLICATION

This application claims the benefit of Korean Patent Application No. 10-2013-0159090, filed Dec. 19, 2013, which is hereby incorporated by reference in its entirety into this application.

### BACKGROUND OF THE INVENTION

1. Technical Field

The present invention relates generally to a data processing apparatus and method. More particularly, the present invention relates to an apparatus and method for processing data between a Universal Serial Bus (USB) device and a host.

2. Description of the Related Art

A Universal Serial Bus (USB) is an interface used to connect a device such as a keyboard, a printer or a portable hard disk to a computer at close range. Further, a USB is a new peripheral connection interface standard commonly proposed by seven companies such as Microsoft, Compaq, DEC, IBM, Canada's Notel, and NEC.

When a USB is used, interfaces for connecting peripherals such as a mouse, a printer, a modem or a speaker to a Personal Computer (PC) can be implemented as a common interface. Further, when peripherals are connected to a PC, all of the peripherals are connected to the same connector without having to separately set software or hardware, so that there is an advantage in that the number of ports can be greatly reduced, installation can be conveniently performed, and the size of a portable PC can be reduced.

Recently, upon performing communication between a host terminal and a USB device which uses a USB, communication is performed via separate data processing apparatuses between the host terminal and the USB device. In particular, such a data processing apparatus is used when the host terminal and the USB device are spaced apart from each other by a predetermined distance.

However, when the host terminal and the USB device perform communication while being spaced apart from each other, a problem arises in that communication speed is deteriorated due to a round trip delay or the like.

### PRIOR ART DOCUMENTS

### Patent Documents

(Patent Document 1) Prior Document 1: Korean Patent Application Publication No. 10-2013-0122339 (Title of invention: Reservation method for avoiding resource reservation conflict upon moving wireless USB device over wireless USB network)

### SUMMARY OF THE INVENTION

Accordingly, the present invention has been made keeping in mind the above problems occurring in the prior art, and an object of the present invention is to provide a data processing apparatus and method, which can solve the problem of deterioration in communication speed by preventing a round trip delay or the like from occurring even when communication is performed between USB devices that are spaced apart from each other.

In accordance with an aspect of the present invention to accomplish the above object, there is provided a data processing apparatus, including a terminal communication unit; a first control unit for extracting a command packet based on a command block wrapper packet; and a first unit-side communication unit for transmitting the command packet to a second unit, wherein when the first unit-side communication unit receives a data status packet, generated based on one or more data packets responding to the command packet, from the second unit, the first control unit extracts a data packet from the data status packet in response to a packet for a data transmission request of a host terminal, and wherein the terminal communication unit transmits the data packet extracted from the data status packet to the host terminal.

The first control unit may be configured to, when the first unit-side communication unit receives one or more data packets from the host terminal, generate an integrated data packet based on the one or more data packets received from the host terminal, and the first unit-side communication unit may be configured to transmit the integrated data packet to the second unit.

The command packet may be a command packet related to information about transmission of data packets from the host terminal, transmission of data to the host terminal, or enumeration, and includes an identifier field for the command packet, a destination field containing Universal Serial Bus (USB) port information of a device, and a command block within the command block wrapper packet.

The integrated data packet may be a packet used when a device desires to one or more pieces of data to the host terminal, and includes an identifier field for the command packet, a destination field containing USB port information of the device, and a data field containing data.

The data included in the integrated data packet may have a variable size depending on a communication environment.

The first control unit may be configured to, when the first unit-side communication unit receives a status packet from the second unit, reconstruct the status packet into a command status wrapper packet, based on the status packet, and the terminal communication unit may be configured to transmit the command status wrapper packet, based on a packet for the data transmission request of the host terminal.

In accordance with another aspect of the present invention to accomplish the above object, there is provided a data processing apparatus, including a second unit-side communication unit for receiving a command packet; a second control unit for reconstructing the command packet into a command block wrapper packet; and a device communication unit for transmitting the command block wrapper packet to a device, wherein the second control unit is configured to, when the device communication unit receives one or more data packets, generate a data status packet, based on the one or more data packets received by the device communication unit, and wherein the second unit-side communication unit transmits the data status packet to the first unit.

The second control unit may be configured to, when the second unit-side communication unit receives an integrated data packet from the first unit, extract a data packet from the integrated data packet, and the device communication unit may be configured to transmit the data packet extracted by the second control unit to the device.

The device communication unit may be configured to, if transmission of the data packet extracted by the second control unit has been terminated, receive a command status wrapper packet from the device, the control unit may be configured to extract a status packet from the command status wrapper packet, and the second unit-side communication unit may be configured to transmit the status packet to the first unit.

The data status packet may be a packet used when the device transfers one or more data packets and status information to the host terminal, and includes an identifier field for the command packet, a destination field containing USB port information of the device, a data field containing data, and a status field containing the status information.

The data included in the data status packet may have a variable size depending on a communication environment.

The data status packet may further include a data residue field containing a difference between an amount of data expected to be received by the host terminal and an amount of data to be transmitted from the device when the difference occurs.

The status packet may be a packet used when the device transfers the command status wrapper packet and the status information together to the host terminal, and includes an identifier field for the command packet, a destination field containing USB port information of the device, and a status field containing the status information.

The status packet may further include a data residue field.

In accordance with a further aspect of the present invention to accomplish the above object, there is provided a data processing method, including transmitting, by a first unit, a command packet extracted based on a received command block wrapper packet to a second unit; transmitting, by the second unit, a command block wrapper packet reconstructed based on the command packet to a device; when the device transmits one or more pieces of data to the second unit, collecting, by the second unit, the one or more pieces of data and transmitting collected data as a data status packet to the first unit; and extracting, by the first unit, a data packet from the data status packet and transmitting the extracted data packet to the host terminal.

The data processing method may further include, when the host terminal transmits one or more pieces of data to the first unit, collecting, by the first unit, the one or more pieces of data and transmitting collected data as an integrated data packet to the second unit; and extracting, by the second unit, a data packet from the integrated data packet and transmitting the data packet to the device.

The data processing method may further include, when transmission of the data packet, extracted from the integrated data packet, from the second unit to the device is completed, receiving, by the second unit, a command status wrapper packet from the device; and extracting, by the second unit, a status packet from the command status wrapper packet and transmitting the status packet to the host terminal.

The command packet may be a command packet related to information about transmission of data packets from the host terminal, transmission of data to the host terminal, or enumeration, and includes an identifier field for the command packet, a destination field containing USB port information of a device, and a command block within the command block wrapper packet.

The data status packet may be a packet used when the device transfers one or more data packets and status information to the host terminal, and includes an identifier field for the command packet, a destination field containing USB port information of the device, a data field containing data, and a status field containing the status information.

The integrated data packet may be a packet used when a device desires to one or more pieces of data to the host terminal, and includes an identifier field for the command packet, a destination field containing USB port information of the device, and a data field containing data.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a data communication system according to an embodiment of the present invention;

FIG. 2 is a diagram showing a USB mass storage protocol layer according to an embodiment of the present invention;

FIG. 3 is a diagram showing the flow of a USB mass storage transport protocol according to an embodiment of the present invention;

FIG. 4 is a block diagram showing a first unit according to an embodiment of the present invention;

FIG. 5 is a block diagram showing a second unit according to an embodiment of the present invention;

FIG. 6 is a diagram showing the flow of data reception performed by a device according to an embodiment of the present invention;

FIG. 7 is a diagram showing the flow of data transmission performed by a device according to an embodiment of the present invention;

FIG. 8 is a diagram showing the format of a data transmission packet in an Ethernet environment according to an embodiment of the present invention;

FIG. 9 is a first reference diagram showing the format of a data transmission packet in a USB-over-Network environment according to an embodiment of the present invention;

FIG. 10 is a diagram showing a command block wrapper;

FIG. 11 is a diagram showing a command status wrapper;

FIG. 12 is a second reference diagram showing the format of a data transmission packet in a USB-over-Network environment according to an embodiment of the present invention;

FIG. 13 is a diagram showing the flow of data reception performed by a host terminal according to a comparative embodiment; and

FIG. 14 is a diagram showing the flow of data transmission performed by a host terminal according to a comparative embodiment.

### DESCRIPTION OF THE PREFERRED EMBODIMENTS

Embodiments of the present invention are described with reference to the accompanying drawings in order to describe the present invention in detail so that those having ordinary knowledge in the technical field to which the present invention pertains can easily practice the present invention. However, the present invention can be implemented in various forms and is not limited by the following embodiments. In the attached drawings, components which are not directly related to the description of the present invention will be omitted so as to clearly describe the present invention. It should be noted that the same reference numerals are used to designate the same or similar elements throughout the drawings.

In the present specification, it should be understood that a representation indicating that a first component “includes” a second component means that the first component may further include other components, and is not intended to exclude a possibility that other components or parts will be present unless they are differently defined in the present specification.

Throughout the entire specification, it should be understood that a representation indicating that a first component is “electrically connected” to a second component may include the case where the first component is connected to the second component with some other component interposed therebetween, as well as the case where the first component is “directly connected” to the second component.

Hereinafter, a data processing apparatus and method according to embodiments of the present invention will be described in detail with reference to the attached drawings.

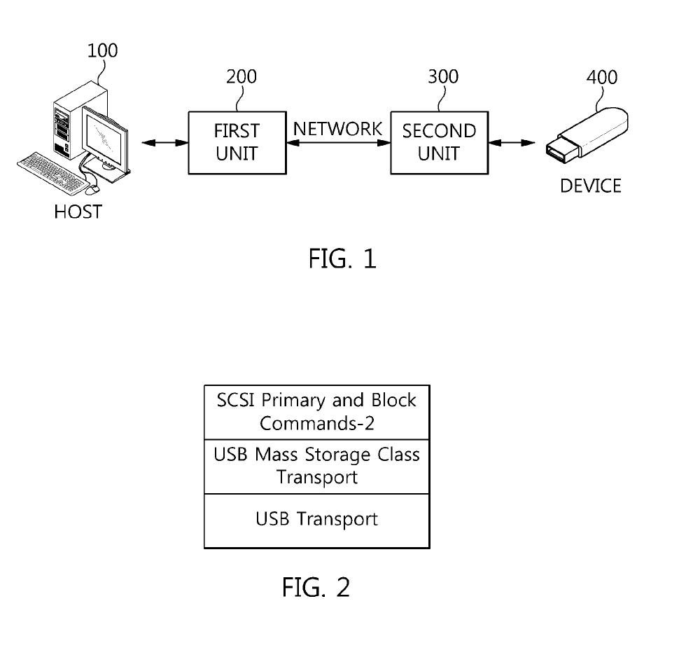

First, a data communication system will be described with reference to FIG. 1.

FIG. 1 is a block diagram showing a data communication system according to an embodiment of the present invention.

Referring to FIG. 1, a data communication system according to an embodiment of the present invention includes a host terminal 100, a first unit 200, a second unit 300, and a device 400.

The host terminal 100 performs data communication with the first unit 200. Further, examples of the host terminal 100 according to the embodiment of the present invention may be classified into mobile (mobile/portable) terminals and stationary terminals depending on whether it is movable. Further, mobile terminals can be classified into handheld terminals and vehicle-mounted terminals depending on whether a user can personally carry it.

The host terminal 100 described in the present specification may be one of a mobile phone, a smart phone, a notebook computer (laptop computer), a digital broadcasting terminal, a Personal Digital Assistant (PDA), a Portable Multimedia Player (PMP), a navigation terminal, a digital television (TV), and a desktop computer. However, the present invention is not limited to those examples and may be any of terminals capable of performing data communication with the first unit 200.

The first unit 200 communicates with the host terminal 100 or the second unit 300.

The first unit 200 according to the embodiment of the present invention may communicate with the host terminal 100 through a USB connection. Further, the first unit 200 may communicate with the second unit 300 through a Local Area Network (LAN), an Internet Protocol (IP) network, or a wired cable. However, the present invention is not limited to such examples. The first unit 200 may perform data communication with the second unit 300 regardless of a communication method. The first unit 200 according to the embodiment of the present invention may be connected to the host terminal 100 through a USB cable to enable communication therewith.

The second unit 300 communicates with the first unit 200 or the device 400. The second unit 300 according to the embodiment of the present invention may communicate with the device 400 through a USB connection. Further, the second unit 300 may also communicate with the first unit 200 through a LAN, an IP network or a wired cable. However, the present invention is not limited to the above examples. The second unit 300 may perform data communication with the first unit 200 regardless of a communication method. The second unit 300 according to the embodiment of the present invention may be connected to the device 400 through a USB cable to enable communication therewith.

The device 400 may be a device enabling communication through a USB connection. Hereinafter, a description will be made using an example in which the device 400 is a USB storage medium (USB mass storage).

FIG. 2 is a diagram showing a USB mass storage protocol layer according to an embodiment of the present invention.

In order to exchange data, the USB mass storage device 400 must go through a total of three protocol layers. Referring to FIG. 2, USB communication performed by the USB mass storage device 400 according to the embodiment of the present invention is implemented such that a USB Mass Storage Class Transport protocol layer is applied to a basic USB protocol layer, and a Small Computer System Interface (SCSI) Primary and Block Commands-2 (SCSI Primary Command (SPC)-2, SCSI Block Commands (SBC)-2) protocol layer is also applied to the USB Mass Storage Class Transport protocol. This protocol layer structure may also be applied to the host terminal 100.

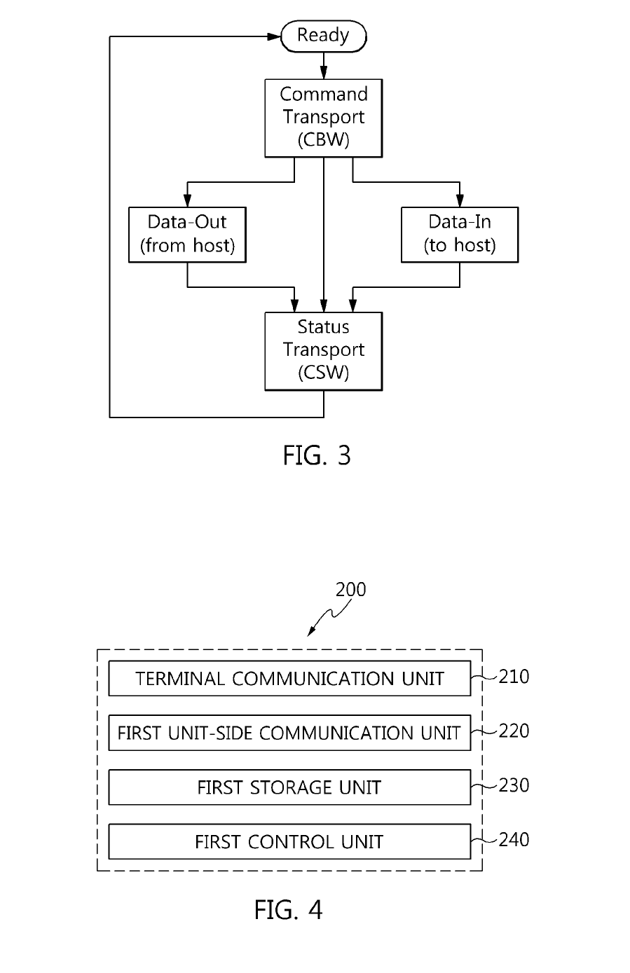

Further, the USB mass storage device 400 according to the embodiment of the present invention complies with USB Mass Storage Class Bulk-Only Transport specification. The protocol presented by this specification is divided into three stages, as shown in FIG. 3.

FIG. 3 is a diagram showing the flow of a USB Mass Storage transport protocol according to an embodiment of the present invention.

Referring to FIG. 3, a Command Block Wrapper (hereinafter referred to as “CBW”) includes commands related to the transmission of data. For example, CBW may include information about a command block. In accordance with the embodiment of the present invention, the data of the device 400 may be transmitted from the device 400 to the host terminal 100 depending on information contained in the CBW (Data In from host).

Further, the data of the host terminal 100 may be transmitted from the host terminal 100 to the device 400 (Data Out from host).

After the CBW has been transferred to the device, data transaction is performed depending on the content of the CBW. Thereafter, the device 400 transmits a Command Status Wrapper (hereinafter referred to as “CSW”) with transmission result status information carried by the CSW.

FIG. 4 is a block diagram showing the first unit according to an embodiment of the present invention.

The first unit 200 according to the embodiment of the present invention includes a terminal communication unit 210, a first unit-side communication unit 220, a first storage unit 230, and a first control unit 240. However, the configuration shown in FIG. 4 is not an essential configuration, and the first unit 200 may freely include more components or fewer components than those shown in the drawing.

The terminal communication unit 210 communicates with the host terminal 100. The terminal communication unit 210 may communicate with the host terminal 100 through a USB connection.

The first unit-side communication unit 220 communicates with the second unit-side communication unit 320 of the second unit 300. The first unit-side communication unit 220 performs wired or wireless communication with the second unit-side communication unit 320 of the second unit 300. The present invention can be used regardless of a communication method between the first unit-side communication unit 220 and the second unit-side communication unit 320.

The first storage unit 230 stores various types of data received through the first unit 200. Further, the first storage unit 240 may also store an algorithm or a program for operating the first unit 200.

The first control unit 240 controls the overall operation of the first unit 200.

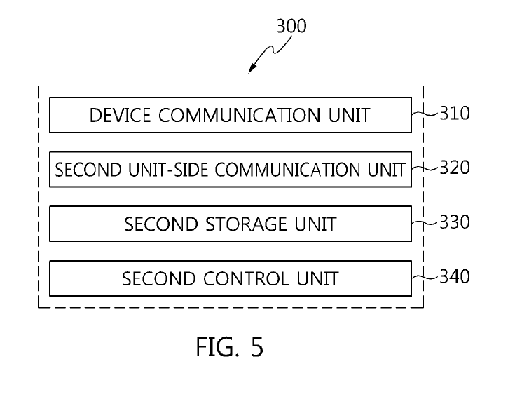

FIG. 5 is a block diagram showing the second unit according to an embodiment of the present invention.

The second unit 300 according to the embodiment of the present invention includes a device communication unit 310, a second unit-side communication unit 320, a second storage unit 330 and a second control unit 340. However, the configuration shown in FIG. 5 is not an essential configuration and the second unit 300 may freely include more components or fewer components than those shown in the drawing.

The device communication unit 310 communicates with the device 400. The device communication unit 310 may communicate with the device 400 through a USB connection.

The second unit-side communication unit 320 communicates with the first unit-side communication unit 220 of the first unit 200. The second unit-side communication unit 320 performs wired or wireless communication with the first unit-side communication unit 220 of the first unit 200. The present invention can be used regardless of a communication method between the first unit-side communication unit 220 and the second unit-side communication unit 320.

The second storage unit 330 stores various types of data received through the second unit 300. Further, the second storage unit 330 may also store an algorithm or a program for operating the second unit 300.

The second control unit 340 controls the overall operation of the second unit 300.

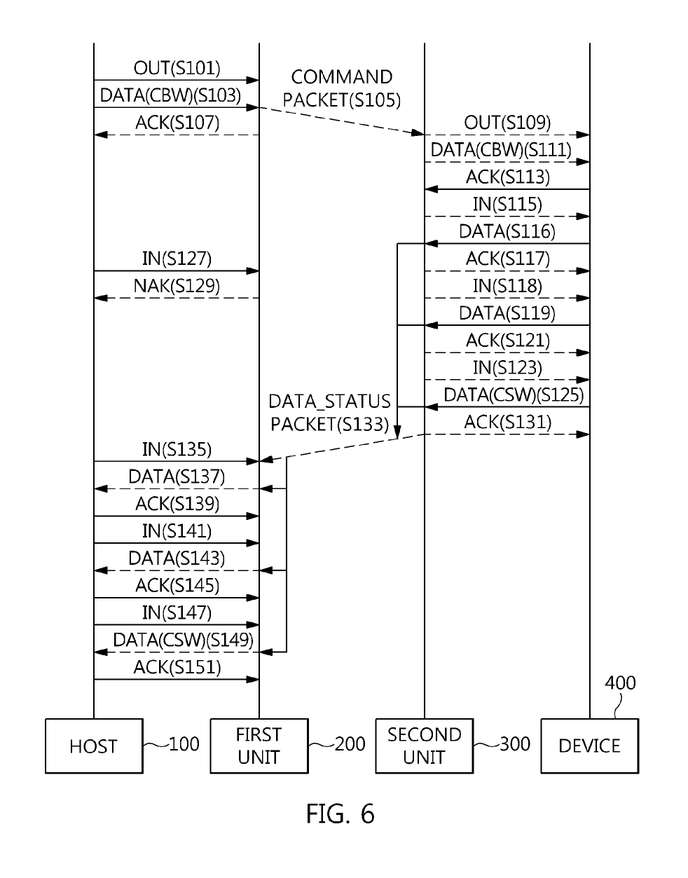

Below, a method in which the device 400 according to an embodiment of the present invention receives data will be described in detail with reference to FIG. 6.

FIG. 6 is a diagram showing the flow of data reception performed by the device according to an embodiment of the present invention.

Referring to FIG. 6, the host terminal 100 transmits a first OUT packet to the terminal communication unit 210 of the first unit 200 at step S101.

Thereafter, the host terminal 100 transfers a CBW packet to the terminal communication unit 210 of the first unit 200 at step S103. The CBW packet according to the embodiment of the present invention includes commands related to data transmission. For example, the CBW packet may include information about a command block. In accordance with the embodiment of the present invention, data may be transmitted from the device 400 to the host terminal 100 depending on information contained in the CBW packet.

The first unit-side communication unit 220 of the first unit 200 transmits a command packet (COMMAND) to the second unit-side communication unit 320 of the second unit 300 at step S105. In accordance with the embodiment of the present invention, the first control unit 240 of the first unit 200 extracts a COMMAND packet based on the received CBW packet and first OUT packet. The structure of the command packet will be described later.

The terminal communication unit 210 of the first unit 200 transmits an acknowledgement (ACK) packet to the host terminal 100 at step S107.

Thereafter, if the second unit 300 receives the command packet, the device communication unit 310 of the second unit 300 transmits a second OUT packet to the device 400 at step S109.

The device communication unit 310 of the second unit 300 transmits a CBW packet to the device 400 at step S111.

In accordance with the embodiment of the present invention, the second control unit 340 of the second unit 300 reconstructs a CBW packet based on the received command packet.

Thereafter, the device 400 transmits an ACK packet to the device communication unit 310 of the second unit 300 at step S113.

The device communication unit 310 of the second unit 300 transmits a first IN packet to the device 400 at step S115.

The device 400 transmits a first data packet in response to the first IN packet at step S116.

The device communication unit 310 of the second unit 300 transmits an ACK packet to the device 400 at step S117.

The device communication unit 310 of the second unit 300 transmits a second IN packet to the device 400 at step S118.

The device 400 transmits a second data packet in response to the second IN packet at step S119.

The device communication unit 310 of the second unit 300 transmits an ACK packet to the device 400 at step S121.

The device communication unit 310 of the second unit 300 transmits a third IN packet to the device 400 at step S123.

The device 400 transmits a CSW packet in response to the third IN packet at step S125.

The host terminal 100 transmits a data request IN packet for a data transmission request to the terminal communication unit 210 of the first unit 200 at step S127.

The terminal communication unit 210 transmits a Negative ACK (NAK) packet to the host terminal 100 at step S129.

Here, the IN packet for data transmission, transmitted from the host terminal 100, and the NAK packet, transmitted from the first unit 200, may be sent before the second unit 300 receives a CSW packet from the device 400.

Even if the terminal communication unit 210 of the first unit 200 according to the embodiment of the present invention receives the IN packet for data transmission from the host terminal 100, it transmits a NAK packet. Typically, the NAK packet is a packet required to indicate a failure in the execution of a specific function, such as a failure in packet reception. However, in accordance with the embodiment of the present invention, the terminal communication unit 210 may receive again the IN packet for data transmission by randomly sending a NAK packet to the host terminal 100.

Unless the terminal communication unit 210 randomly transmits a NAK packet, the host terminal 100 requests the transmission of data even if the second unit has not yet received the entire data from the device 400. In order to solve such a problem, the first unit 200 transmits a NAK packet to the host terminal 100. That is, as the terminal communication unit 210 transmits the NAK packet to the host terminal 100, it may gain the time needed to receive a data status packet (DATA STATUS) from the second unit 300.

The device communication unit 310 of the second unit 300 transmits an ACK packet to the device 400 at step S131.

The second unit-side communication unit 320 of the second unit 300 transmits a data status packet to the first unit-side communication unit 220 of the first unit 200 at step S133.

The second control unit 340 according to an embodiment of the present invention generates a data status packet based on the first data packet, the second data packet, and the CSW packet. That is, the second control unit 340 does not immediately transmit the received data to the first unit 200. The second control unit 340 generates the data status packet by collecting the data transmitted from the device 400, and the second unit-side communication unit 320 transmits the generated data status packet.

The host terminal 100 transmits a fourth IN packet to the terminal communication unit 210 of the first unit 200 in response to a NAK packet at step S135.

The terminal communication unit 210 transmits a first data packet based on the data status packet, in response to the fourth IN packet at step S137.

The host terminal 100 transmits an ACK packet to the terminal communication unit 210 at step S139.

The host terminal 100 transmits a fifth IN packet to the terminal communication unit 210 of the first unit 200 at step S141.

The terminal communication unit 210 transmits a second data packet based on the data status packet, in response to the fifth IN packet at step S143.

The host terminal 100 transmits an ACK packet to the terminal communication unit 210 at step S145.

The host terminal 100 transmits a sixth IN packet to the terminal communication unit 210 of the first unit 200 at step S147.

The terminal communication unit 210 transmits a CSW packet based on the data status packet, in response to the sixth IN packet at step S149.

The host terminal 100 transmits an ACK packet to the terminal communication unit 210 at step S151.

That is, when receiving the data status packet, the first unit 200 according to the embodiment of the present invention stores it in the first storage unit 240. Thereafter, the first control unit 240 extracts data packets responding to respective IN packets from the data status packet. Then, the terminal communication unit 210 transmits the extracted data packets to the host terminal 100. Further, the fourth to sixth IN packets according to the embodiment of the present invention may be packets for a data transmission request.

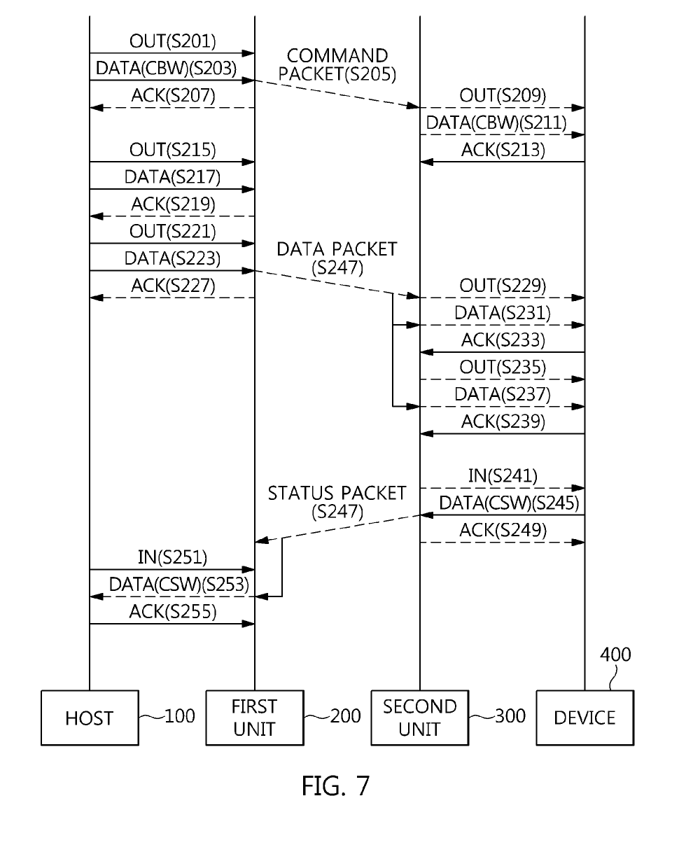

Below, a method by which the device 400 transmits data according to an embodiment of the present invention will be described in detail with reference to FIG. 7.

FIG. 7 is a diagram showing the flow of data transmission performed by the device according to an embodiment of the present invention.

Referring to FIG. 7, the host terminal 100 transmits a first OUT packet to the terminal communication unit 210 of the first unit 200 at step S201.

Thereafter, the host terminal 100 transfers a CBW packet to the terminal communication unit 210 of the first unit 200 at step S203. The CBW packet according to the embodiment of the present invention includes commands related to data transmission. For example, the CBW packet may include information about a command block. In accordance with the embodiment of the present invention, data may be transmitted from the host terminal 100 to the device 400 depending on the information included in the CBW packet.

The first unit-side communication unit 220 of the first unit 200 transmits a COMMAND packet to the second unit-side communication unit 320 of the second unit 300 at step S205. In accordance with the embodiment of the present invention, the first control unit 240 of the first unit 200 extracts a command packet based on the received CBW packet and first OUT packet. The structure of the command packet will be described later.

The terminal communication unit 210 of the first unit 200 transmits an ACK packet to the host terminal 100 at step S207.

Thereafter, when the second unit 300 receives a command packet, the device communication unit 310 of the second unit 300 transmits a second OUT packet to the device 400 at step S209.

The device communication unit 310 of the second unit 300 transmits a CBW packet to the device 400 at step S211.

In accordance with the embodiment of the present invention, the second control unit 340 of the second unit 300 reconstructs a CBW packet based on the received command packet.

Thereafter, the device 400 transmits an ACK packet to the device communication unit 310 of the second unit 300 at step S213.

The host terminal 100 transmits a third OUT packet to the terminal communication unit 210 of the first unit 200 at step S215.

The host terminal 100 transmits a third data packet to the terminal communication unit 210 of the first unit 200 at step S217.

The terminal communication unit 210 of the first unit 200 transmits an ACK packet to the host terminal 100 at step S219.

The host terminal 100 transmits a fourth OUT packet to the terminal communication unit 210 of the first unit 200 at step S221.

The host terminal 100 transmits a fourth data packet to the terminal communication unit 210 of the first unit 200 at step S223.

The first unit-side communication unit 220 of the first unit 200 transmits an integrated data packet to the second unit-side communication unit 320. The first control unit 240 of the first unit 200 generates the integrated data packet based on the third data packet and the fourth data packet. The integrated data packet may be generated by integrating the third data packet with the fourth data packet. The first unit 200 according to the embodiment of the present invention collects data to be transmitted by the host terminal 100 and transmits the collected data as the integrated data packet without immediately transmitting the data from the host terminal 100 to the second unit 300 when the data is transmitted from the host terminal 100.

The terminal communication unit 210 of the first unit 200 transmits an ACK packet to the host terminal 100 at step S227.

The device communication unit 310 transmits a fifth OUT packet to the device 400 at step S229.

The device communication unit 310 transmits a third data packet to the device 400 at step S231.

The device communication unit 310 transmits an ACK packet to the device 400 at step S233.

The device communication unit 310 transmits a sixth OUT packet to the device 400 at step S235.

The device communication unit 310 transmits a fourth data packet to the device 400 at step S237.

The device communication unit 310 transmits an ACK packet to the device 400 at step S239.

Below, the above-described steps S229 to S239 will be described in detail. In accordance with an embodiment of the present invention, when receiving the integrated data packet, the second unit 300 stores the integrated data packet in the second storage unit 330. Thereafter, the second control unit 340 extracts pieces of data from the integrated data packet in response to the transmission of respective OUT packets. Thereafter, the device communication unit 310 transmits the extracted data to the device 400.

The device communication unit 310 transmits an IN packet for the completion of data transmission to the device 400 at step S241.

The device 400 transmits a CSW packet to the device communication unit 310 in response to the IN packet for the completion of data transmission at step S245.

The second unit-side communication unit 320 transmits a status packet to the first unit-side communication unit 220 at step S247. The second control unit extracts the status packet from the CSW packet. The status packet will be described later.

The device communication unit 310 transmits an ACK packet to the device 400 at step S249.

The host terminal 100 transmits a seventh IN packet for a data reception request to the terminal communication unit 210 at step S251.

The terminal communication unit 210 transmits a CSW packet to the host terminal 100 in response to the seventh IN packet at step S253. The first storage unit 240 stores the status packet transmitted from the second unit-side communication unit 320. When the terminal communication unit 210 receives the seventh IN packet, the first control unit 240 reconstructs the status packet into a CSW packet. Thereafter, the terminal communication unit 210 transmits the reconstructed CSW packet to the host terminal 100. That is, the first unit reconstructs the status packet into the CSW packet in response to the seventh IN packet and then transmits the CSW packet, without immediately transmitting the received status packet to the host terminal 100 when the status packet is transmitted. The seventh IN packet according to the embodiment of the present invention may also be a packet for the data transmission request.

The host terminal 100 transmits an ACK packet to the terminal communication unit 210 at step S255.

The terminal communication unit 210 of the first unit 200 transmits the ACK packet to the host terminal 100 at step S227.

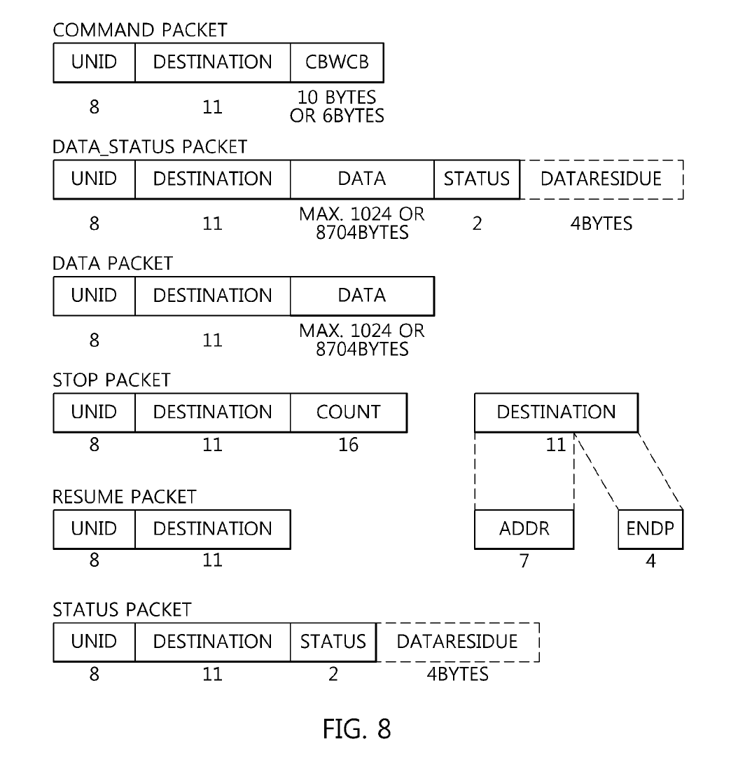

Below, individual packets according to embodiments of the present invention will be described in detail with reference to FIGS. 8 to 12.

FIG. 8 is a diagram showing the format of a data transmission packet in an Ethernet environment according to an embodiment of the present invention.

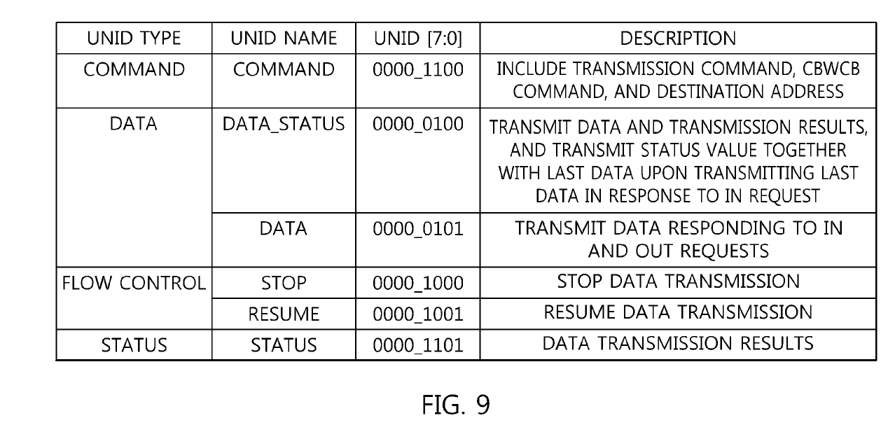

FIG. 9 is a first reference diagram showing the format of a data transmission packet in a USB-over-Network environment according to an embodiment of the present invention.

Below, a description will be made using an example in which data communication is performed in the Ethernet environment. However, the environment of the present invention is not limited thereto.

Referring to FIGS. 8 and 9, a Cyclic Redundancy Check (CRC) is omitted from each packet used for data communication between the first unit 200 and the second unit 300 according to an embodiment of the present invention. However, the packet of the present invention is not limited thereto. That is, the present invention may be applied regardless of whether a CRC is omitted or not from the packet.

A ‘Unique Identifier (UNID)’ included in the packet according to the embodiment of the present invention starts with 0000 which is a reserved value of a USB Product Identifier (PID) (4 bits), and enables a USB packet for mass storage to be distinguished from other USB packets that are not for mass storage. The type, function and configuration of packets including UNID are described below.

A command packet according to an embodiment of the present invention is a command packet related to information required for reading, writing or enumeration of data. The command packet according to an embodiment of the present invention includes an identifier field for the command packet, a destination field containing the USB port information of the device 400, and a Command Block Wrapper Command Block (CBWCB) field indicating a command block retrieved from the CBW packet transmitted from the host terminal 100. The CBWCB according to the embodiment of the present invention may have a length of 6 bytes or 10 bytes according to the type of command.

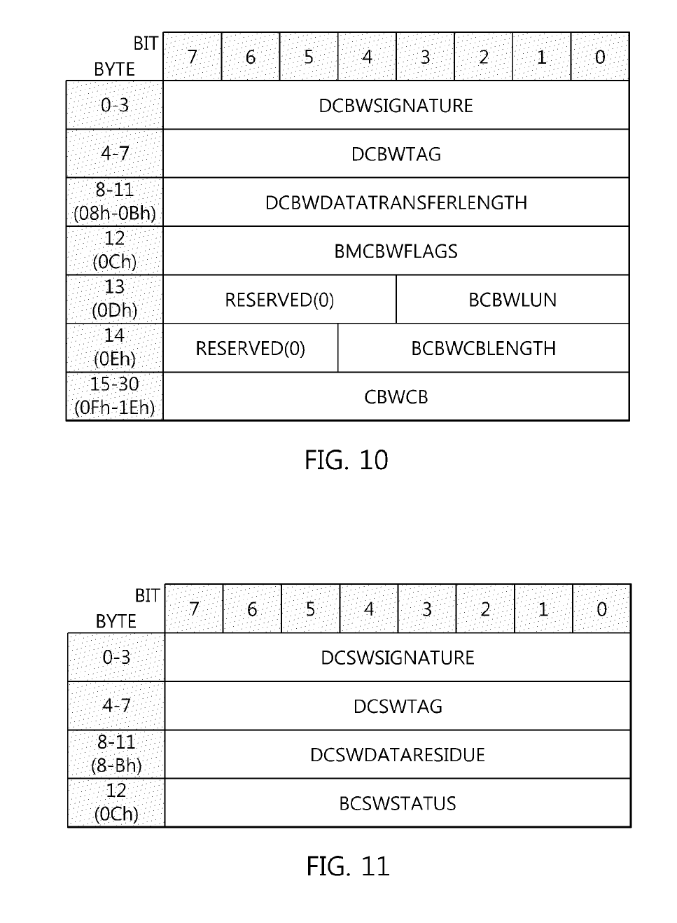

The first unit 200 according to an embodiment of the present invention may identify a CBW packet by analyzing a dCBWSignature field of FIG. 10 or 11, and identify the length of 6 or 10 bytes by using a bCBWCBLength field.

FIG. 10 is a diagram showing a command block wrapper and FIG. 11 is a diagram showing a command status wrapper.

Referring to FIG. 10, dCBWDataTransferLength indicates a field indicating the length of data to be transmitted or received. Since a value indicating the length of data is present even in the CBWCB, there is no need to send dCBWDataTransferLength to the device.

A description will be made by referring back to FIGS. 8 and 9.

A data status packet according to an embodiment of the present invention is a packet used to transfer status information, together with data, from the device 400 to the host terminal 100. A device 400 according to a conventional embodiment transmitted data in response to a data transmission request from the host terminal 100, received an ACK packet, and then received a status IN request from the host terminal 100 and transmitted the status information.

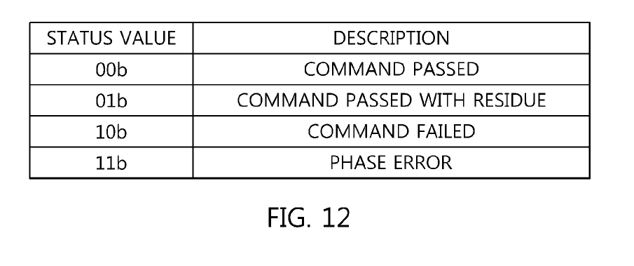

In accordance with the embodiment of the present invention, the second unit 300 may generate various types of signals or transactions which have been described above, collect the data and the status information, and transmit the collected data and status information to the first unit 200. When data transmitted from the second unit 300 to the first unit 200 is divided into a plurality of packets, the second unit 300 carries status information only in a last packet and transmits the packets. A data status packet according to an embodiment of the present invention includes an identifier (UNID) field for a command packet, a destination field containing the USB port information of the device, a data field containing data, and a status field containing status information. Data is variable depending on the conditions of networks, and in the case of the Ethernet exemplified in the present specification, the size of data is 1500 bytes when the size of a payload is generally limited, and the size of data is 9000 bytes for a jumbo frame. When the unit of the USB mass storage data is 512 bytes, the size of maximum data that can be transmitted at one time is defined as two USB mass storage packets, each having 512 bytes, or as 17 jumbo frames. That is, data having a size of 1024 or 8704 bytes can be transmitted or received. Further, the status field may have values illustrated in FIG. 12.

FIG. 12 is a second reference diagram showing the format of a USB mass storage data transmission packet in a USB-over-Network environment according to an embodiment of the present invention.

In accordance with an embodiment of the present invention, when there is a difference between the amount of data expected by the host terminal 100 and the amount of data to be transmitted from the device 400, the value of status information is 01b, as shown in FIG. 12. The difference in the amount of data is contained in a DataResidue field of a separate data status packet and then the data status packet is transmitted to the host terminal 100. The DataResidue field according to the embodiment of the present invention may be optimally attached to the end of the data status packet only when necessary.

An integrated data packet (DATA Packet of FIGS. 8 and 9) is a packet used when data is transmitted from the device 400 to the host terminal 100. A device 400 according to a conventional embodiment transmitted the data through a procedure in which data was transmitted or received between the first unit 200 and the second unit 300 in response to a data transmission or reception request received from the host terminal 100 and an ACK packet was exchanged therebetween.

In contrast, the present invention integrates a plurality of pieces of data into a single packet and allows the first unit 200 or the second unit 300 to perform transaction for the ACK packet instead of the device. Accordingly, the amount of data to be transmitted is reduced while the transfer rate is improved. An integrated data packet includes an identifier (UNID) field for a command packet, a destination field containing the USB port information of the device, and a data field containing data. The size of the data is variable depending on the conditions of network or communication conditions. In the case of the Ethernet exemplified in the present specification, the size of data is 1500 bytes when the size of a payload is generally limited, and the size of data is 9000 bytes for a jumbo frame. When the unit of the USB mass storage data is 512 bytes, the size of maximum data that can be transmitted at one time is defined as two USB mass storage packets, each having 512 bytes, or as 17 jumbo frames. That is, data having a size of 1024 or 8704 bytes can be transmitted or received.

A stop packet (STOP) according to an embodiment of the present invention is a packet enabling simple flow control such that, when data is exchanged between buffers disposed between the first unit 200 and the second unit 300, if a reception-side buffer is full or cannot receive data, a transmission-side buffer stops the transmission of data.

When a specific buffer requests the stop of transmission, if the last packet number of packets that have been received up to the current time from the start of data reception is recorded in a count field and a resulting stop packet is sent, the transmission-side buffer stores a packet subsequent to the count value in the buffer, and first reads and transmits the packet stored in the buffer if a resume (RESUME) packet is received.

The resume packet according to an embodiment of the present invention is a packet enabling the transmission of data to be resumed in the case where the reception-side buffer is full or cannot receive data and then the transmission-side buffer stops the transmission of data when data is exchanged between buffers disposed between the first unit 200 and the second unit 300. That is, when the reception-side buffer which issued a stop command returns to a state enabling the reception of data, the reception-side buffer transmits a resume packet to the transmission-side unit, thus allowing the transmission of data to be resumed.

A status packet (STATUS) according to an embodiment of the present invention is a packet used when the device 400 transfers status information together with a CSW packet to the host terminal 100. In the past, the device 400 according to a conventional embodiment transferred only a CSW packet to the host terminal 100.

The status packet according to an embodiment of the present invention includes an identifier (UNID) field for a command packet, a destination field containing the USB port information of the device, and a status field containing status information. The status packet may further include a DataResidue field.

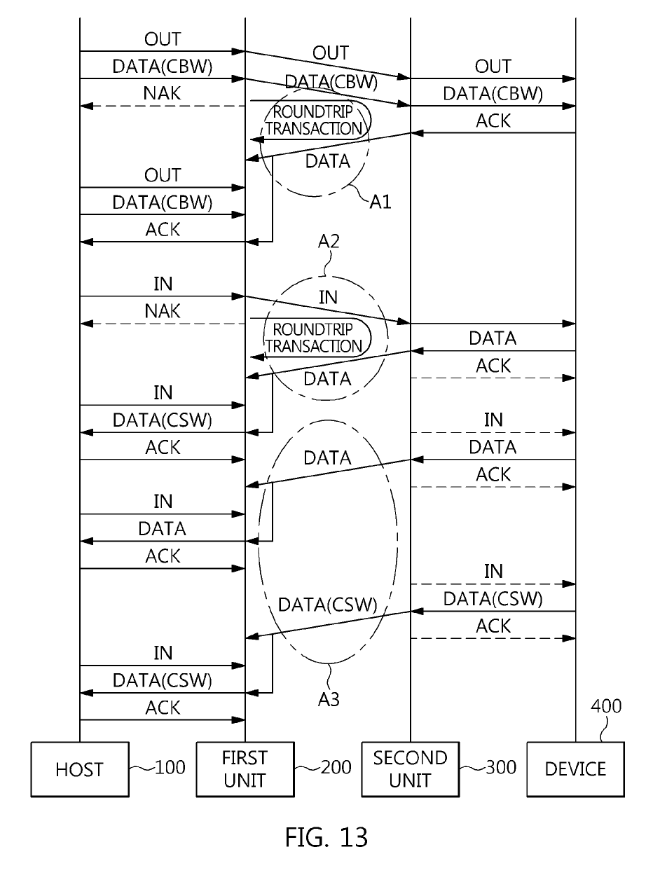

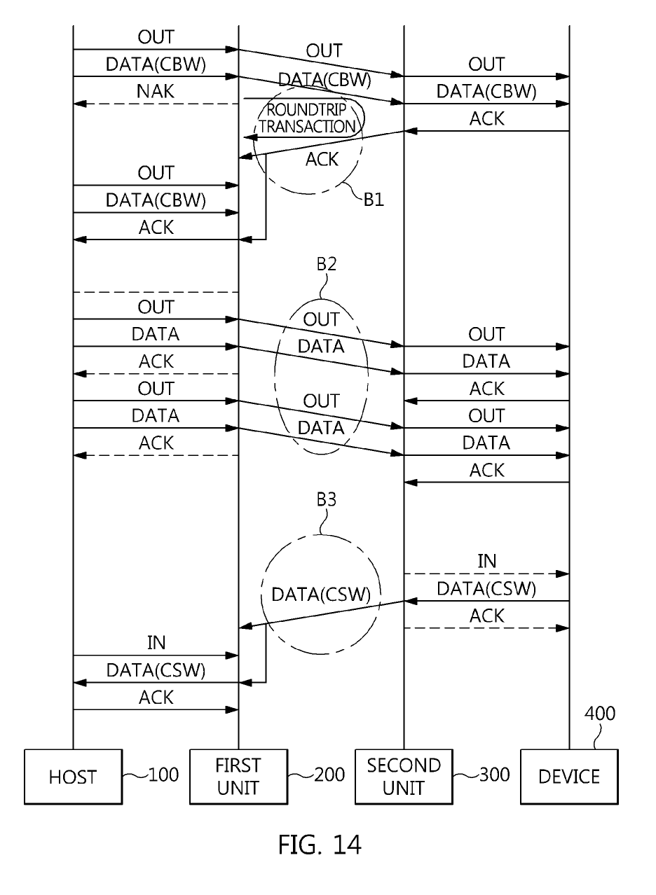

Below, comparative embodiments will be described with reference to FIGS. 13 and 14.

FIG. 13 is a diagram showing the flow of data reception performed by a host terminal according to a comparative embodiment.

Referring to FIG. 13, a round trip delay appears in regions A1 and A2 of the comparative embodiment. Referring back to FIG. 6, it can be seen that a round trip delay does not occur in the present invention. Further, in region A3 of the comparative embodiment, the second unit 300 transmits data to the first unit 200 several times, whereas, in the present invention, the second unit 300 transmits data to the first unit 200 only once by means of a data status packet, as shown in FIG. 6. Therefore, the second unit 300 of the present invention can perform data transmission faster than the second unit 300 in the comparative embodiment.

FIG. 14 is a diagram showing the flow of data transmission performed by the host terminal according to a comparative embodiment.

Referring to FIG. 14, a round trip delay appears in region B1 of the comparative embodiment. Referring back to FIG. 7, it can be seen that a round trip delay does not occur in the present invention. Further, in region B2 of the comparative embodiment, the first unit 200 transmits data to the second unit 300 several times, whereas, in the present invention, the first unit 200 transmits data to the second unit 300 only once by means of an integrated data packet, as shown in FIG. 7. Therefore, the first unit 200 of the present invention can perform data transmission faster than the first unit 200 in the comparative embodiment.

It can be seen that the second unit 300 of the present invention shown in FIG. 7 transmits a status packet to the first unit 200, but, in region B3 of FIG. 14, the second unit 300 transmits a CSW packet.

In accordance with embodiments of the present invention, since the first unit or the second unit collects data to configure a separate packet and transmits the packet, the number of times that data is transmitted between the first unit and the second unit can be reduced, thus improving a data transfer rate between the units.

In accordance with embodiments of the present invention, the first unit generates a packet based on an OUT packet and a data packet, thus preventing a round trip delay from occurring.

Although the preferred embodiments of the present invention have been disclosed in detail, the scope of the present invention is not limited by those embodiments, and those skilled in the art will appreciate that various modifications, additions and substitutions are possible, without departing from the scope and spirit of the basic concept of the invention as disclosed in the accompanying claims.

What is claimed is:

1. A data processing apparatus, comprising:
a terminal communication unit;
a first control unit for extracting a command packet based on a command block wrapper packet; and
a first unit-side communication unit for transmitting the command packet to a second unit,
wherein when the first unit-side communication unit receives a data status packet, generated based on one or more data packets responding to the command packet, from the second unit, the first control unit extracts a data packet from the data status packet in response to a packet for a data transmission request of a host terminal, and
wherein the terminal communication unit transmits the data packet extracted from the data status packet to the host terminal.

2. The data processing apparatus of claim 1, wherein:
the first control unit is configured to, when the first unit-side communication unit receives one or more data packets from the host terminal, generate an integrated data packet based on the one or more data packets received from the host terminal, and
the first unit-side communication unit is configured to transmit the integrated data packet to the second unit.

3. The data processing apparatus of claim 2, wherein the command packet is a command packet related to information about transmission of data packets from the host terminal, transmission of data to the host terminal, or enumeration, and includes an identifier field for the command packet, a destination field containing Universal Serial Bus (USB) port information of a device, and a command block within the command block wrapper packet.

4. The data processing apparatus of claim 2, wherein the integrated data packet is a packet used when a device desires to one or more pieces of data to the host terminal, and includes an identifier field for the command packet, a destination field containing USB port information of the device, and a data field containing data.

5. The data processing apparatus of claim 4, wherein the data included in the integrated data packet has a variable size depending on a communication environment.

6. The data processing apparatus of claim 1, wherein:
the first control unit is configured to, when the first unit-side communication unit receives a status packet from the second unit, reconstruct the status packet into a command status wrapper packet, based on the status packet, and
the terminal communication unit is configured to transmit the command status wrapper packet, based on a packet for the data transmission request of the host terminal.

7. A data processing apparatus, comprising:
a second unit-side communication unit for receiving a command packet;
a second control unit for reconstructing the command packet into a command block wrapper packet; and
a device communication unit for transmitting the command block wrapper packet to a device,
wherein the second control unit is configured to, when the device communication unit receives one or more data packets, generate a data status packet, based on the one or more data packets received by the device communication unit, and
wherein the second unit-side communication unit transmits the data status packet to the first unit.

8. The data processing apparatus of claim 7, wherein:
the second control unit is configured to, when the second unit-side communication unit receives an integrated data packet from the first unit, extract a data packet from the integrated data packet, and
the device communication unit is configured to transmit the data packet extracted by the second control unit to the device.

9. The data processing apparatus of claim 8, wherein:
the device communication unit is configured to, if transmission of the data packet extracted by the second control unit has been terminated, receive a command status wrapper packet from the device,
the control unit is configured to extract a status packet from the command status wrapper packet, and
the second unit-side communication unit is configured to transmit the status packet to the first unit.

10. The data processing apparatus of claim 7, wherein the data status packet is a packet used when the device transfers one or more data packets and status information to the host terminal, and includes an identifier field for the command packet, a destination field containing USB port information of the device, a data field containing data, and a status field containing the status information.

11. The data processing apparatus of claim 10, wherein the data included in the data status packet has a variable size depending on a communication environment.

12. The data processing apparatus of claim 10, wherein the data status packet further includes a data residue field containing a difference between an amount of data expected to be received by the host terminal and an amount of data to be transmitted from the device when the difference occurs.

13. The data processing apparatus of claim 9, wherein the status packet is a packet used when the device transfers the command status wrapper packet and the status information together to the host terminal, and includes an identifier field for the command packet, a destination field containing USB port information of the device, and a status field containing the status information.

14. The data processing apparatus of claim 13, wherein the status packet further includes a data residue field.

15. A data processing method, comprising:
transmitting, by a first unit, a command packet extracted based on a received command block wrapper packet to a second unit;
transmitting, by the second unit, a command block wrapper packet reconstructed based on the command packet to a device;
when the device transmits one or more pieces of data to the second unit, collecting, by the second unit, the one or more pieces of data and transmitting collected data as a data status packet to the first unit; and
extracting, by the first unit, a data packet from the data status packet and transmitting the extracted data packet to the host terminal.

16. The data processing method of claim 15, further comprising:
when the host terminal transmits one or more pieces of data to the first unit, collecting, by the first unit, the one or more pieces of data and transmitting collected data as an integrated data packet to the second unit; and
extracting, by the second unit, a data packet from the integrated data packet and transmitting the data packet to the device.

17. The data processing method of claim 16, further comprising, when transmission of the data packet, extracted from the integrated data packet, from the second unit to the device is completed:
receiving, by the second unit, a command status wrapper packet from the device; and
extracting, by the second unit, a status packet from the command status wrapper packet and transmitting the status packet to the host terminal.

18. The data processing method of claim 15, wherein the command packet is a command packet related to information about transmission of data packets from the host terminal, transmission of data to the host terminal, or enumeration, and includes an identifier field for the command packet, a destination field containing USB port information of a device, and a command block within the command block wrapper packet.

19. The data processing method of claim 15, wherein the data status packet is a packet used when the device transfers one or more data packets and status information to the host terminal, and includes an identifier field for the command packet, a destination field containing USB port information of the device, a data field containing data, and a status field containing the status information.

20. The data processing method of claim 16, wherein the integrated data packet is a packet used when a device desires to one or more pieces of data to the host terminal, and includes an identifier field for the command packet, a destination field containing USB port information of the device, and a data field containing data.
